(19) United States
(12) Patent Application Publication
(10) Pub. No.: US 2016/0004513 A1
(43) Pub. Date: Jan. 7, 2016

(54) DESIGN ASSISTING SYSTEM, DESIGN ASSISTING METHOD, AND STORAGE MEDIUM STORING PROGRAM THEREFOR

(71) Applicant: HITACHI, LTD., Tokyo (JP)

(72) Inventors: Tomohiro HANADA, Tokyo (JP); Naoaki YOKOI, Tokyo (JP)

(73) Assignee: HITACHI, LTD., Tokyo (JP)

(21) Appl. No.: 14/770,306

(22) PCT Filed: Jul. 19, 2013
(86) PCT No.: PCT/JP2013/069626

§ 371 Date: Aug. 25, 2015

(51) Int. Cl. G06F 9/44; G06F 9/445

(52) U.S. Cl. CPC G06F 8/20; G06F 9/445

(57) ABSTRACT

To design parameters for building a system quickly, it is provided a design assisting system, comprising: a processor configured to execute a program; and a memory configured to store the program to be executed by the processor. The memory is configured to store a plurality of parameter sets for defining usage of resources of a computer system on which a business operation is run. The processor is configured to: calculate a resource value score of each resource for each of the plurality of parameter sets, based on information for defining items to be taken into account in system designing; sum up the calculated resource value scores for each of the plurality of parameter sets separately; and determine a priority level of each of the plurality of parameter sets, based on the resource value scores summed up for each of the plurality of parameter sets separately.

### BACKGROUND OF THE INVENTION

This invention relates to a data analysis technology of a design assisting system, and more particularly, to a method of adjusting parameters in a business operation system.

Speed is demanded in development of a business operation system for carrying out a business. Cloud systems, which allow for easy procurement of necessary resources, are garnering high expectations as a solution for speedy system development.

System development involves designing parameters of an OS, middleware, and the like so that performance requirements are fulfilled and that the amount of physical resources necessary to build the system, such as processors (CPUs), is minimized. When applied to the actual system, however, the designed parameter values do not always yield expected performance. Thus, time and energy need to be spent by readjusting the parameters repeatedly until required performance is achieved.

For example, in JP 08-235011 A, there is disclosed a continuous running method. In the method, different environment spaces (a production environment space and a test environment space) are built on the same computer, and a communication management module couples a terminal apparatus to one of the environment spaces that is to be used. A business operation program in each environment space accesses a resource to be used by a logical resource name, and a resource management module converts the logical resource name into a physical resource name. In the case where a resource for which arbitrary business operation processing has been executed in the test environment space is taken over to the production environment space, for example, a physical resource name that corresponds to the relevant logical resource name in the production environment space is changed in the resource management module to the physical resource name of the resource for which the processing has been executed, and this resource is migrated to the production environment space seamlessly, without executing new processing such as re-IPL as in the past. Parallel running in the production environment space and the test environment space is also conducted.

### SUMMARY OF THE INVENTION

In the system disclosed in JP 08-235011 A, a system can be built quickly by applying prepared snapshots, which reflect required performance. However, changing parameters in relation to the free capacities of physical resources is not possible because snapshots need to be prepared in advance.

A system built in an environment with limited resources, such as a private cloud, needs to suit resource situations for effective resource utilization and the improvement of resource integration ratio. Unless the knowledge of an experienced engineer is shared, the system designing skill of the engineer remains an individually-possessed skill, and building the system can take long.

The representative one of inventions disclosed in this application is outlined as follows. There is provided a design assisting system, comprising: a processor configured to execute a program; and a memory configured to store the program to be executed by the processor. The memory is configured to store a plurality of parameter sets for defining usage of resources of a computer system on which a business operation is run. The processor is configured to: calculate a resource value score of each resource for each of the plurality of parameter sets, based on information for defining items to be taken into account in system designing; sum up the calculated resource value scores for each of the plurality of parameter sets separately; and determine a priority level of each of the plurality of parameter sets, based on the resource value scores summed up for each of the plurality of parameter sets separately.

According to the exemplary embodiment of this invention, parameters for building a system (virtual computer) in a virtual environment can be designed quickly. Problems, configurations, and effects other than those described above are clarified by the following description of embodiments of this invention.

### BRIEF DESCRIPTION OF THE DRAWINGS

FIG. 1 is a block diagram for illustrating the logical configuration of a parameter designing system according to an embodiment of this invention.

FIG. 2 is a block diagram for illustrating the physical configuration of the parameter designing system according to this embodiment.

FIG. 3 is a diagram for illustrating an example of the system template of this embodiment.

FIG. 4 is a diagram for illustrating an example of the discretionary distribution definition of this embodiment.

FIG. 5 is a diagram for illustrating an example of the resource-by-resource distribution definition of this embodiment.

FIG. 6 is a diagram for illustrating an example of the resource value information of this embodiment.

FIG. 7 is a diagram for illustrating an example of the unit resource usage definition of this embodiment.

FIG. 8 is a diagram for illustrating an example of the parameter sets of this embodiment.

FIG. 9 is a diagram for illustrating an example of the parameter set management table of this embodiment.

FIG. 10 is a flow chart for the parameter set generating processing of this embodiment.

FIG. 11 is a flow chart for the parameter set measuring processing of this embodiment.

FIG. 12 is a diagram for illustrating an example of the resource usage calculation table of this embodiment.

FIG. 13 is a flow chart for the resource value calculating processing of this embodiment.

FIG. 14 is a diagram for illustrating an example of the resource value score calculation table of this embodiment.

FIG. 15 is a diagram for illustrating an example of the resource value score calculation table of this embodiment.

FIG. 16 is a diagram for illustrating an example of the parameter set selection screen of this embodiment.

### DETAILED DESCRIPTION OF THE PREFERRED EMBODIMENTS

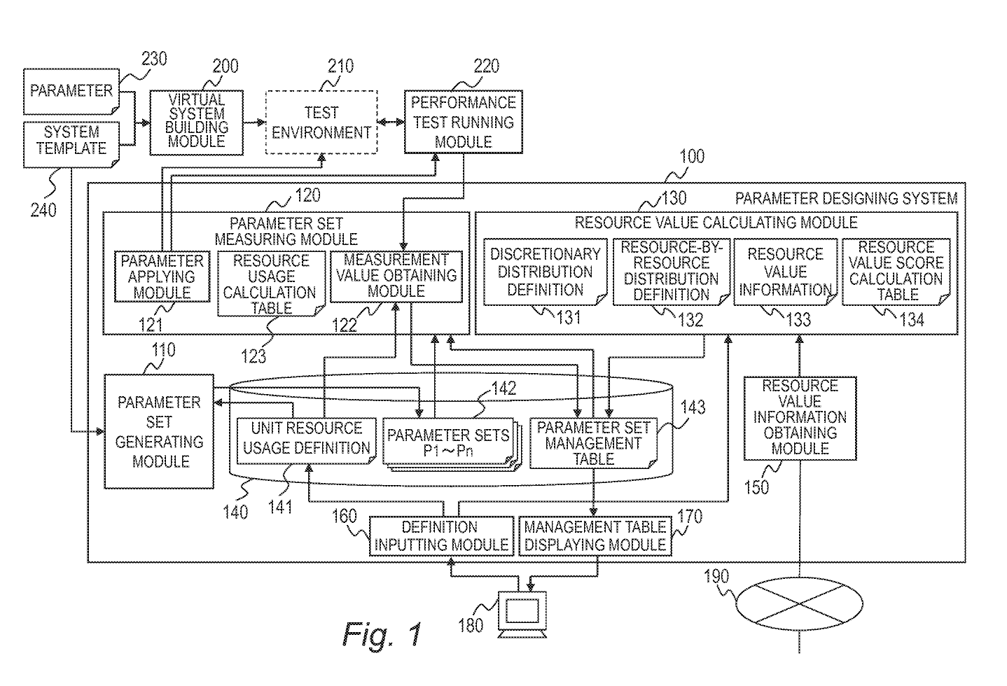

FIG. 1 is a block diagram for illustrating the logical configuration of a parameter designing system 100 according to an embodiment of this invention.

The parameter designing system 100 outputs a list of parameter sets (a parameter set management table 143), which are expressed in scores in a manner that reflects the know-how of parameter designing and resource situations based on a unit resource usage definition 141, a discretionary distribution definition 131, and resource value information 133.

The parameter designing system 100 includes a parameter set generating module 110, a parameter set measuring module 120, a resource value calculating module 130, a definition inputting module 160, and a management table displaying module 170.

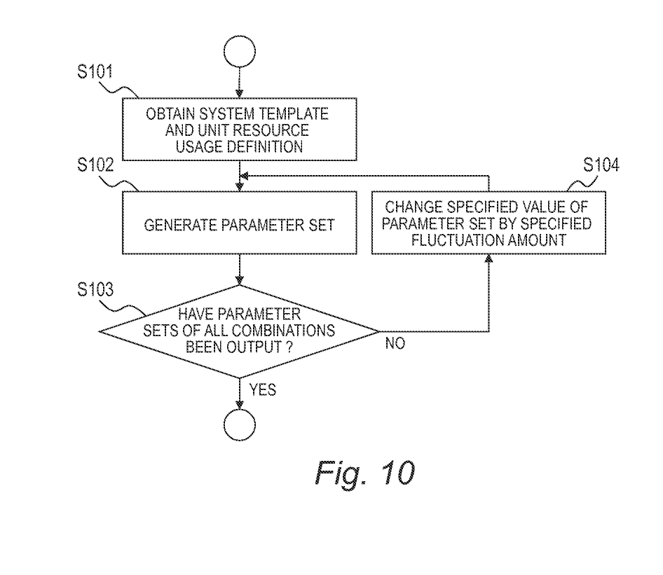

A system template 240 is input to the parameter set generating module 110, which then executes parameter generating processing (FIG. 10) to generate parameter sets 142. The system template 240 serves as a form for the configuration of each node and for parameters of software in the node when a virtual system is built.

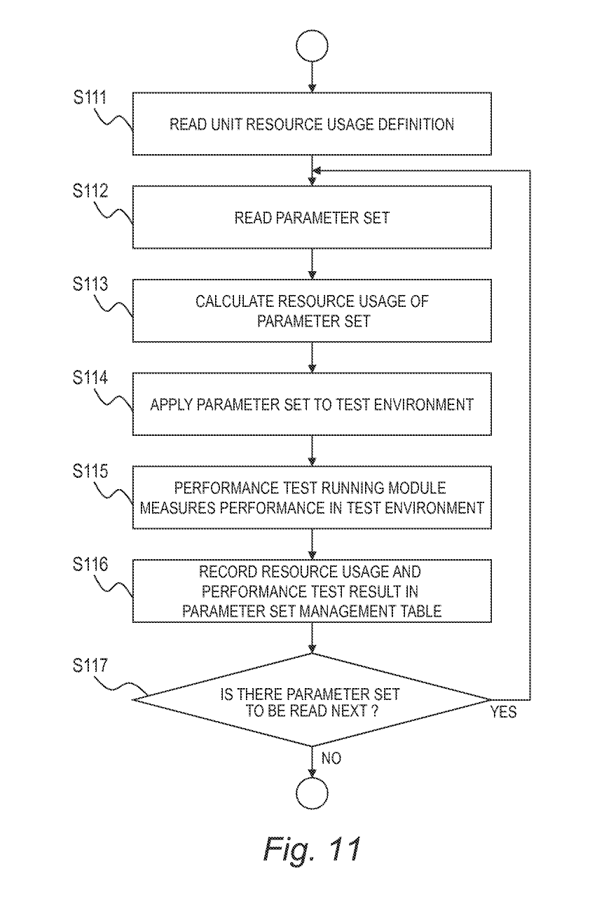

The unit resource usage definition 141 is input to the parameter set measuring module 120, which then executes parameter set measuring processing (FIG. 11) to record an actual measurement value 1433 in the parameter set management table 143. The parameter set measuring module 120 includes a parameter applying module 121 and a measurement value obtaining module 122.

The parameter applying module 121 applies the parameter sets 142 to a test environment 210. The parameter applying module 121 may automatically apply a parameter set to a business operation system (a production environment). The measurement value obtaining module 122 obtains the result of measuring performance in the test environment from a performance test running module 220, and records the obtained result in the parameter set management table 143.

The parameter set measuring module 120 can access a resource usage calculation table 123. The resource usage calculation table 123 is intermediate data that is used by the parameter set measuring module 120 to calculate the resource usage of a parameter set. The resource usage calculation table 123, which is illustrated inside the parameter set measuring module 120 in FIG. 1, is actually stored in a memory or a storage apparatus 140.

The unit resource usage definition 141 is input to the resource value calculating module 130, which then executes the parameter set measuring processing (FIG. 11) to record the actual measurement value 1433 in the parameter set management table 143. The parameter set measuring module 120 includes the parameter applying module 121 and the measurement value obtaining module 122.

The resource value calculating module 130 can access the discretionary distribution definition 131, a resource-by-resource distribution definition 132, and the resource value information 133.

The discretionary distribution definition 131 defines the know-how of parameter designing, specifically, which resource value is given importance (the priority level of a resource value), in the form of the distribution of resource value scores. The resource-by-resource distribution definition 132 defines which resource is given importance (how a resource is weighted) in the form of the distribution of resource value scores. The resource value information 133 defines the value of a resource which changes dynamically depending on the situation of the system.

The resource value calculating module 130 can access a resource value score calculation table 134. The resource value score calculation table 134 is intermediate data that is used by the resource value calculating module 130 to calculate the resource value score of a parameter set. The resource value score calculation table 134, which is illustrated inside the resource value calculating module 130 in FIG. 1, is actually stored in the memory or the storage apparatus 140.

The storage apparatus 140 stores the unit resource usage definition 141, the parameter sets 142, and the parameter set management table 143.

The unit resource usage definition 141 defines changes in resource (a CPU, a memory, a network band, and the like) usage at parameters of an OS and middleware. The parameter sets 142 are each a list of parameter values that are set by taking the resource utilization ratio into account. The parameter set management table 143 is a table used to manage, for each parameter set, the resource usage, performance measurement values, and resource value scores of the parameter set.

The parameter designing system 100 may include a resource value information obtaining module 150. While a user of the parameter designing system 100 creates the resource value information 133 in this embodiment, the resource value information obtaining module 150 may obtain information via a network 190 to obtain the state of the computer system so that resource value information may automatically be created.

The definition inputting module 160 allows the user of the parameter designing system 100 to input, via a terminal 180, input information such as the unit resource usage definition 141, the discretionary distribution definition 131, the resource-by-resource distribution definition 132, and the resource value information 133 to the parameter designing system 100.

The management table displaying module 170 outputs screen data for displaying a parameter set selection screen to the terminal 180.

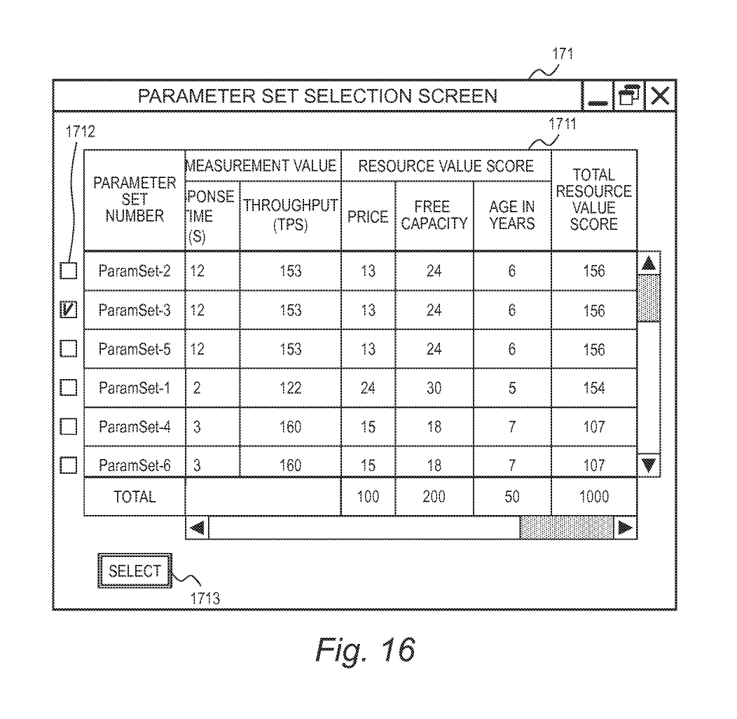

The terminal 180 is a computer that includes a processor (CPU), a memory, a non-volatile storage apparatus, an input apparatus, a display apparatus, and a communication interface. The user of the parameter designing system 100 inputs the definitions 131, 132, 133, and 141 to the terminal 180, and the terminal 180 displays the definitions 131, 132, 133, and 141. The terminal 180 also displays the parameter set management table 143 in the parameter set selection screen, which is denoted by 171 (FIG. 16).

A virtual system building module 200 builds a virtual computer (the test environment 210) in a virtualized environment based on a parameter 230 and the system template 240. The virtual system building module 200, which is not included in the parameter designing system 100 in the example of FIG. 1, may be included in the parameter designing system 100.

The performance test running module 220 measures a performance value related to a system performance requirement, such as the throughput. The performance test running module 220, which is not included in the parameter designing system 100 in the example of FIG. 1, may be included in the parameter designing system 100.

This embodiment describes an example in which the parameter sets 142 are expressed in scores based on the discretionary distribution definition 131 and the resource value information 133. Additional information such as the resource-by-resource distribution definition 132 may be used in combination with the discretionary distribution definition 131 and the resource value information 133 so that the parameter sets 142 are expressed in scores based more flexibly on the know-how of parameter designing or resource situations.

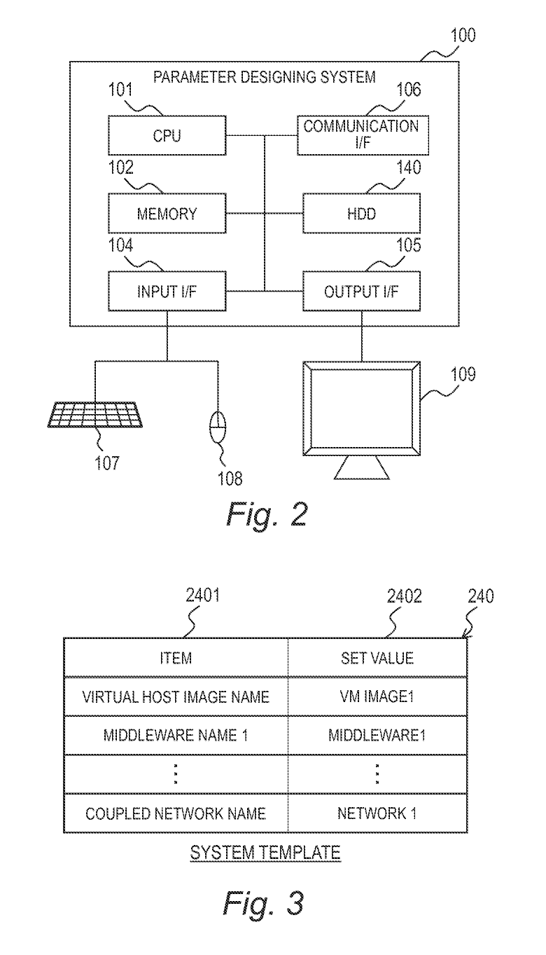

FIG. 2 is a block diagram for illustrating the physical configuration of the parameter designing system 100 according to this embodiment.

The parameter designing system 100 is a computer that includes a processor (CPU) 101, a memory 102, a non-volatile storage apparatus (HDD) 140, and a communication interface 106.

The processor 101 executes programs stored in the memory 102.

The memory 102 is a high-speed, volatile storage apparatus such as a dynamic random access memory (DRAM), and stores an operating system (OS) and an application program. The processor 101 executes the operating system, thereby implementing basic functions of the parameter designing system 100, and executes the application program, thereby implementing functions that are provided by the parameter designing system 100 (functions of the parameter generating module 110, the parameter set measuring module 120, the resource value calculating module 130, the definition inputting module 160, and the management table displaying module 170).

The storage apparatus 140 is a large-capacity, non-volatile storage apparatus such as a magnetic storage apparatus or a flash memory, and stores programs executed by the processor 101 and data used when the programs are executed. In short, a program that the processor 101 executes is read out of the storage apparatus 140 and loaded onto the memory 102 to be executed by the processor 101. For example, as described above, the storage apparatus 140 stores the unit resource usage definition 141, the parameter sets 142, and the parameter set management table 143.

The communication interface 106 couples the parameter designing system 100 to the terminal 180 and to the network 190, and controls communication to and from other apparatus.

The parameter designing system 100 may include an input interface 104 and an output interface 105. The input interface 104 receives an input from a keyboard 107 and a mouse 108, which are input devices. The output interface 105 is coupled to a display apparatus 109, and outputs signals for displaying an image to the display apparatus 109.

The parameter designing system 100 is a system that runs on a single or a plurality of computers configured logically or physically. The parameter set generating module 110, the parameter set measuring module 120, and the resource value calculating module 130 may operate in separate threads on the same computer, or may operate on virtual computers that are built on a plurality of physical computer resources.

In the case where the parameter set generating module 110 and the parameter set measuring module 120 operate on different computers, the system needs to have a configuration that allows the parameter set generating module 110 and the parameter set measuring module 120 to access the same storage apparatus (the storage apparatus 140) so that the parameter sets 142 output from the parameter set generating module 110 are input to the parameter set measuring module 120.

In the case where the parameter set measuring module 120 and the resource value calculating module 130 operate on different computers, the system needs to have a configuration that allows the parameter set measuring module 120 and the resource value calculating module 130 to be coupled to the same storage apparatus (the storage apparatus 140) so that the parameter set measuring module 120 and the resource value calculating module 130 record data in one and same parameter set management table 143.

A program executed by a processor of each server is provided to the server via a removable medium (a CD-ROM, a flash memory, or the like) or a network, and is stored in the storage apparatus 140, which is a non-transitory storage medium. It is therefore preferred for each server to include an interface for reading a removable medium.

FIG. 3 is a diagram for illustrating an example of the system template 240 of this embodiment.

The system template 240 is a file that is a form for the configuration of each node and for software parameters in the node, and includes in each row an item 2401 and a set value 2402. The item 2401 indicates a name recognizable to the user of the parameter designing system 100. The set value 2402 indicates a value set in the parameter designing system 100.

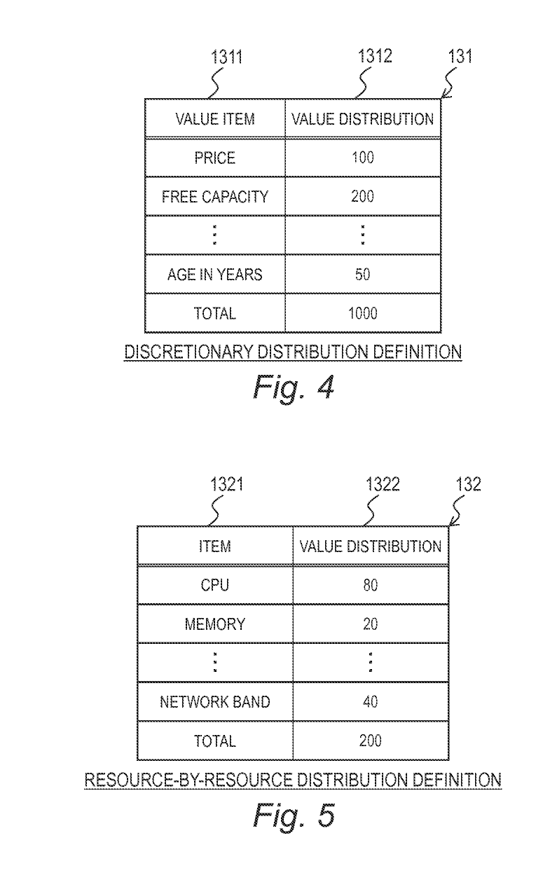

FIG. 4 is a diagram for illustrating an example of the discretionary distribution definition 131 of this embodiment. The discretionary distribution definition 131 is held in the memory 102 or the storage apparatus 140 in a manner that allows the resource value calculating module 130 to access the discretionary distribution definition 131.

The discretionary distribution definition 131 includes in each row a value item 1311 and a value distribution 1312. The value item 1311 indicates the name (label) of a resource value aspect that is recognizable to the user of the parameter designing system 100. The value distribution 1312 indicates one of value scores distributed among resource value aspects that is distributed to the resource value aspect of the row.

The discretionary distribution definition 131 defines, in the form of the distribution of resource value scores, the know-how of parameter designing to be taken into account in system designing, such as “avoid using expensive resources in order to cut the cost of physical resources”, and “avoid using a resource that is small in free capacity so as not to affect other business operation systems operating on the same physical server”, namely, which resource value is given importance (how a resource value is weighted). The discretionary distribution definition 131 defines the know-how of parameter designing so that a high resource value score is distributed to a high priority resource. The total of the value distribution 1312 equals the total score values of the parameter sets 142.

FIG. 5 is a diagram for illustrating an example of the resource-by-resource distribution definition 132 of this embodiment. The resource-by-resource distribution definition 132 is held in the memory 102 or the storage apparatus 140 in a manner that allows the resource value calculating module 130 to access the resource-by-resource distribution definition 132.

The resource-by-resource distribution definition 132 includes in each row an item 1321 and a value distribution 1322. A resource defined in the unit resource usage definition 141 is specified as the item 1321. The value distribution 1322 indicates one of value scores distributed among resources that is distributed to the resource of the row.

The resource-by-resource distribution definition 132 defines, in the form of the distribution of resource value scores, the know-how of parameter designing to be taken into account in system designing, specifically, which resource is given importance (how a resource is weighted) when the priority of a value such as free capacity varies from one resource to another. In other words, the resource-by-resource distribution definition 132 defines the know-how of parameter designing so that a high resource value score is distributed to a high priority resource. The resource-by-resource distribution definition 132 may be calculated automatically from the resource value information 133, or may be created manually by the user.

The resource value calculating module 130 follows the resource-by-resource distribution definition 132 in redistributing on a resource-by-resource basis resource value scores that have been distributed among resource values.

The resource-by-resource distribution definition 132, which is expressed in value distribution in the example of FIG. 5, may be expressed in the free capacities of resources or the ages in years of resources.

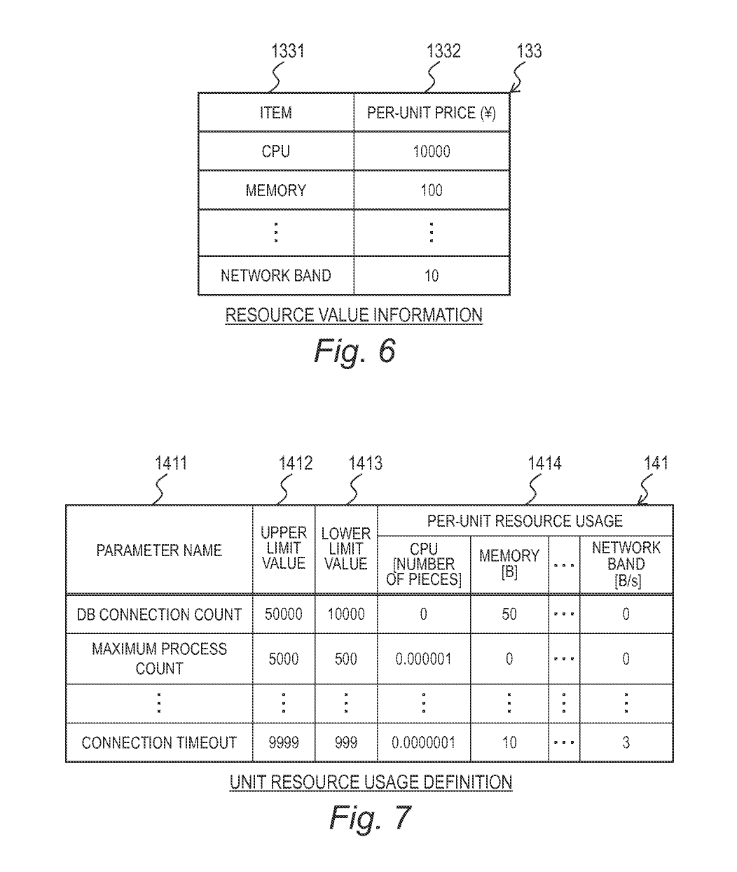

FIG. 6 is a diagram for illustrating an example of the resource value information 133 of this embodiment. The resource value information 133 of FIG. 6 is an example of resource value information about the price of FIG. 4. The resource value information 133 may instead be expressed in the free capacities of physical resources (for example, the free capacities of physical resources that provide a private cloud environment) or the like.

The resource value information 133 is held in the memory 102 or the storage apparatus 140 in a manner that allows the resource value calculating module 130 to access the resource value information 133.

The resource value information 133 includes in each row an item 1331 and a per-unit price 1332. A resource defined in the unit resource usage definition 141 is specified as the item 1331. The unit price of the resource of the row, for example, a price per CPU or a per-byte price of a memory, is specified as the per-unit price 1332.

The resource value information 133 is used to calculate resource value scores, and defines the value of a resource which dynamically changes depending on the situation of the system. In the resource value information 133 of FIG. 6, which is about price, the value of a resource is changed by a change in the price of hardware (parts) that forms the system. In the case where the resource value information 133 is about the free capacities described above, the value of a resource changes dynamically depending on the situation of the system.

FIG. 7 is a diagram for illustrating an example of the unit resource usage definition 141 of this embodiment. The unit resource usage definition 141 is stored in the storage apparatus 140.

The unit resource usage definition 141 defines changes in resource (a CPU, a memory, a network band, and the like) usage at parameters of an OS and middleware.

The unit resource usage definition 141 includes in each row a parameter name 1411, an upper limit value 1412 of a parameter value, a lower limit value 1413 of the parameter value, and per-unit resource usage 1414.

The parameter name 1411 indicates a parameter that can be set in a business operation system of this embodiment. Parameters of the OS, middleware, and the like are listed in a column for the parameter name 1411. The upper limit value 1412 and lower limit value 1413 of a parameter value are an upper limit value and a lower limit value that the parameter set generating module 110 can set to a parameter value of the row. The per-unit resource usage 1414 indicates, for each resource, the value of an increase or decrease caused when the parameter value of the row is shifted by 1.

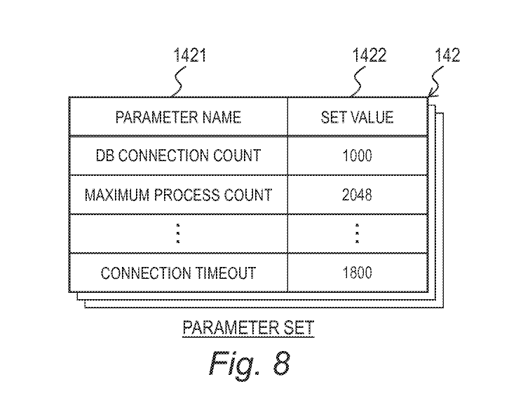

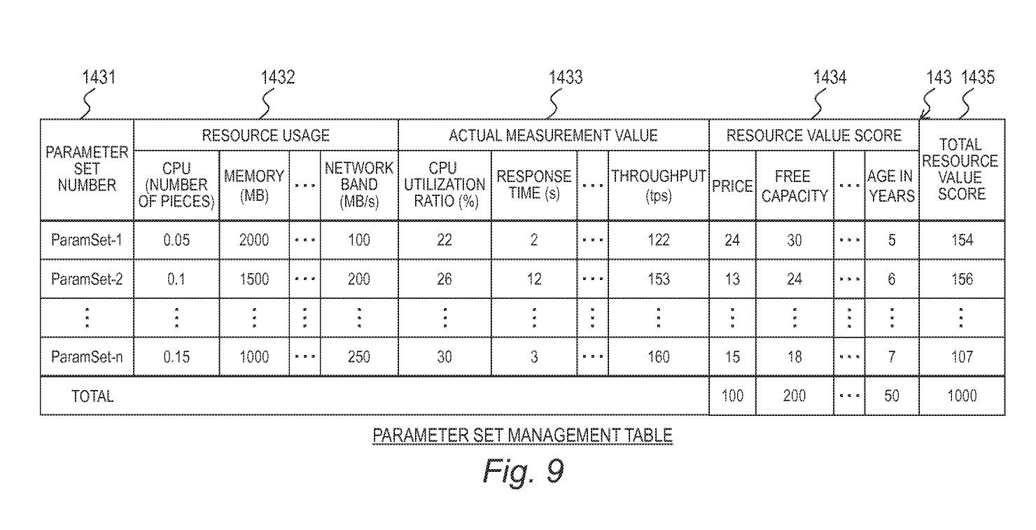

FIG. 8 is a diagram for illustrating an example of the parameter sets 142 of this embodiment. The parameter sets 142 are stored in the storage apparatus 140.

The parameter sets 142 are generated by the parameter set generating module 110 to be stored in the storage apparatus 140, and are each a list of parameter values set in association with the resource usage.

Each parameter set 142 includes in each row a parameter name 1421 and a set value 1422.

The parameter name 1421 indicates a parameter that can be set in a business operation system of this embodiment, and the same item as the parameter name 1411 of the unit resource usage definition 141 is specified as the parameter name 1421. The set value 1422 indicates a value set to the parameter of the row to indicate the resource usage (the amount of physical resources allocated to each system) in the virtual environment.

Each of the plurality of parameter sets shown in FIG. 8 is identified by unique identification information (a parameter set number).

The number and granularity of the parameter sets 142 to be output may be adjusted by defining the fluctuation range of a set value, the number of parameter sets, and the like in the unit resource usage definition 141.

FIG. 9 is a diagram for illustrating an example of the parameter set management table 143 of this embodiment. The parameter set management table 143 is stored in the storage apparatus 140.

The parameter set management table 143 is a table used to manage, for each parameter set, the resource usage, performance measurement values, and resource value scores. The parameter set management table 143 includes in each row a parameter set number 1431, resource usage 1432, an actual measurement value 1433, a resource value score 1434, and a total resource value score 1435.

The parameter set number 1431 in one row is identification information for uniquely identifying a parameter set. The resource usage 1432 indicates the usage of physical resources (a CPU, a memory, a network band, and the like) of the parameter set. The resource usage 1432 is calculated by the parameter set measuring module 120 by multiplying the set value 1422 of the parameter set 142 in question by the pre-unit resource usage 1414 of the unit resource usage definition 141.

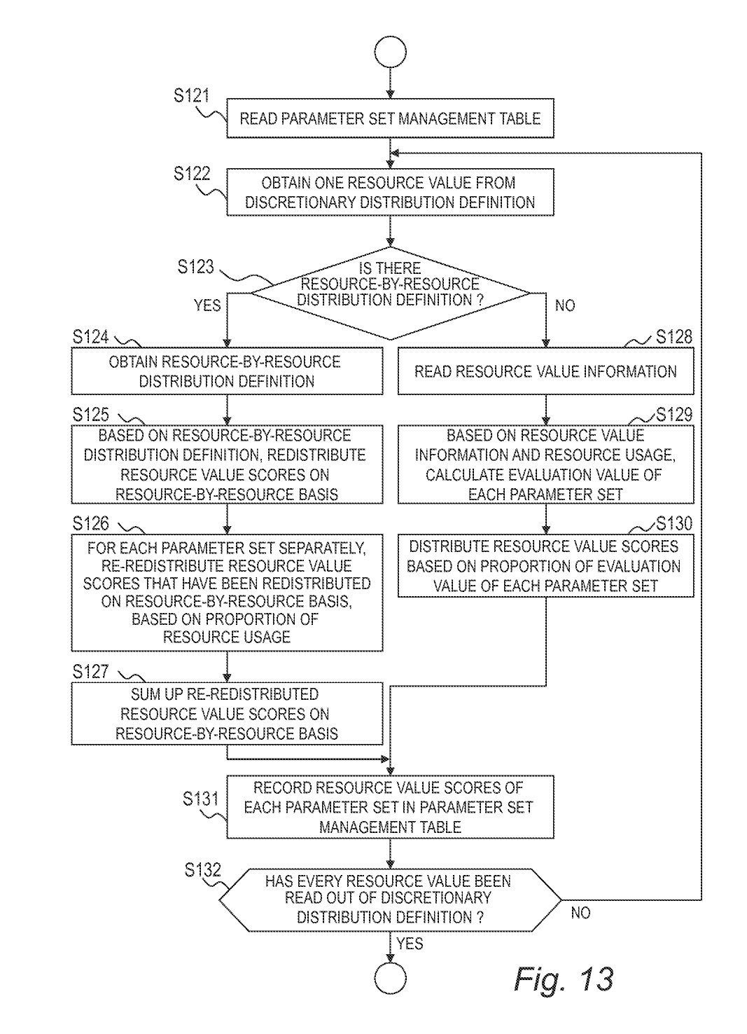

The actual measurement value 1433 indicates measurement values (the CPU utilization ratio, the response time, the throughput, and the like) in a performance test that is run by applying the set value 1422 of the parameter set 142 in question to the test environment 210 by the parameter set measuring module 120. The resource value score 1434 indicates a score that is set for each item 1331 of the discretionary distribution definition 131, and that is calculated by the resource value calculating module 130 by multiplying the resource usage 1432 by the per-unit price 1332 of the resource value information 133. The resource value score 1434 is therefore recorded after resource value calculating processing (FIG. 13) is executed, and is blank before the resource value calculating processing is executed.

The total resource value score 1435 is the sum of resource value scores calculated for the respective resource value aspects of the discretionary distribution definition 131.

The data, information, and definitions described above are in a table format in the drawings, but can be in other formats than the table format.

Processing executed by the parameter designing system 100 of this embodiment is described next.

FIG. 10 is a flow chart for the parameter set generating processing of this embodiment. The parameter set generating processing is processing executed by the parameter set generating module 110, which uses as an input the system template 240 and the unit resource usage definition 141 that are created by the user and which outputs a plurality of parameter sets.

The parameter set generating module 110 first obtains the system template 240 and reads the unit resource usage definition 141 out of the storage apparatus 140 (S101).

The parameter set generating module 110 then generates the parameter sets 142 (S102). For example, the parameter set generating module 110 creates a large number of parameter sets by changing each parameter in given increments or decrements and thus creating combinations of set values of parameters.

The parameter set generating module 110 then determines whether or not parameter sets of all combinations have been output (S103). For example, the parameter set generating module 110 determines whether or not parameter sets have been created for all combinations between the upper limit value 1412 and the lower limit value 1413 of each parameter. In the case where the unit resource usage definition 141 defines the fluctuation range of a set value, the number of parameter sets, and the like, the parameter set generating module 110 may instead determine whether or not those conditions have been fulfilled.

When it is found as a result that parameter sets of all combinations have been output, the parameter set generating processing is ended.

In the case where parameter sets of some combinations have not been output yet, on the other hand, the parameter set generating module 110 changes a set value of a parameter set by a specified fluctuation amount (S104), and returns to Step S102 to continue the parameter set generating processing. The fluctuation amount by which a set value of a parameter set is changed in Step S104 may be managed by the parameter set generating module 110, or may be specified in the unit resource usage definition 141.

FIG. 11 is a flow chart for the parameter set measuring processing of this embodiment. The parameter set measuring processing is processing executed by the parameter set measuring module 120 for each of a plurality of parameter sets generated to calculate resource usage, measure performance values (the CPU utilization ratio, the response time, the throughput, and the like), and record the resource usage and the measurement values in the parameter set management table 143.

The parameter set measuring module 120 first reads the unit resource usage definition 141 out of the storage apparatus 140 (S111), and reads one parameter set 142 out of the storage apparatus 140 (S112).

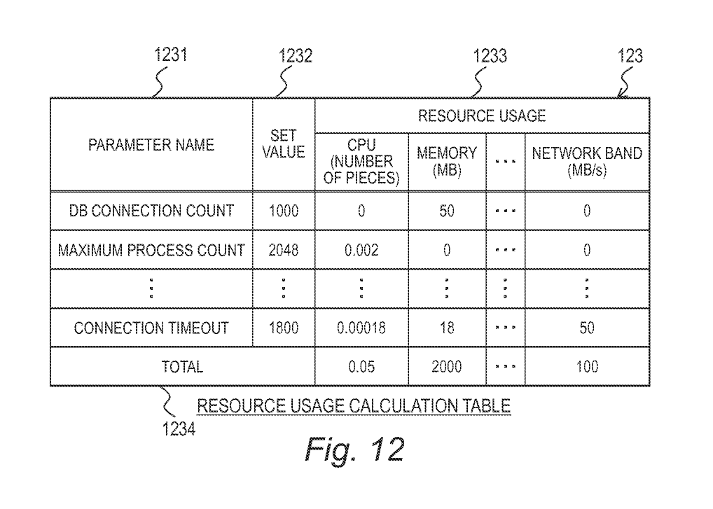

The parameter set measuring module 120 then calculates the resource usage of the read parameter set 142 (S113). Specifically, the parameter set measuring module 120 uses the resource usage calculation table 123 (FIG. 12) to multiply the set value 1422 of the parameter set 142 by the per-unit resource usage 1414 of the unit resource usage definition 141, thus calculating the resource usage of each parameter.

Thereafter, the parameter applying module 121 applies the read parameter set 142 to the test environment 210, and instructs the performance test running module 220 to run a performance test (S114).

Following the instruction from the parameter set measuring module 120, the performance test running module 220 measures performance in the test environment 210 at the applied parameter settings, and sends the result of the measurement to the measurement value obtaining module 122 (S115).

The parameter set measuring module 120 records in the parameter set management table 143 the resource usage calculated in Step S113 and the performance test result obtained in Step S115 (S116).

The parameter set measuring module 120 then determines whether or not there is a parameter set to be read next (S117).

When it is found as a result that the performance has been measured for every parameter set, the parameter set measuring processing is ended. In the case where performance has not been measured for some parameter sets, the parameter set measuring module 120 returns to Step S112 to read the next parameter set.

In the parameter set measuring processing described above, the resource usage is calculated in Steps S111 and S113, and performance in the test environment is envisioned in Steps S112, S114, and S115. Accordingly, when one of the processing steps is unnecessary, only necessary processing steps need to be executed.

Only parameter sets for which actual measurement values fulfill requirements may be used, while parameter sets that fail to fulfill requirements are excluded from those presented to the user. In this case also, it is preferred to calculate resource value scores.

FIG. 12 is a diagram for illustrating an example of the resource usage calculation table 123 of this embodiment. The resource usage calculation table 123 is intermediate data that is used by the parameter set measuring module 120 to calculate the resource usage of a parameter set as illustrated in Step S113 of FIG. 11.

The resource usage calculation table 123 includes in each row a parameter name 1231, a set value 1232, and resource usage 1233.

The parameter name 1231 and the set value 1232 are the same as the parameter name 1421 and the set value 1422 in each parameter set 142. The resource usage 1233 indicates the amount of physical resources used in the parameter of the row.

The resource usage calculation table 123 includes a total 1234 of resource usage as well. The total 1234 indicates the sum of resource usage values of the respective parameters. The set value 1422 of the parameter set 142 is multiplied by the per-unit resource usage 1414 of the unit resource usage definition 141 to calculate the resource usage of each parameter, and the sum of the calculated usage resource values is the resource usage of the parameter set 142.

FIG. 13 is a flow chart for the resource value calculating processing of this embodiment. The resource value calculating processing is executed by the resource value calculating module 130 to express a parameter set in scores based on the discretionary distribution definition 131, the resource-by-resource distribution definition 132, and the resource value information 133, which are defined by the resource value calculating module 130, and on the resource usage, and to record the calculated score values in the parameter set management table 143.

The resource value calculating module 130 first reads the parameter set management table 143 out of the storage apparatus 140 (S121), and obtains one value item 1311 from the discretionary distribution definition 131 (S122).

The resource value calculating module 130 then determines whether or not there is the resource-by-resource distribution definition 132 (S123).

When it is found as a result that there is the resource-by-resource distribution definition 132, the resource value calculating module 130 obtains the resource-by-resource distribution definition 132 (S124) and, based on the obtained resource-by-resource distribution definition 132, redistributes resource value scores on a resource-by-resource basis (S125). The resource value calculating module 130 then re-redistributes among parameter sets the resource value scores that have been redistributed on a resource-by-resource basis, based on the proportion of the resource usage (S126). In Step S126, the resource value scores are distributed in proportion to the reciprocal number of the priority level, for example. The re-redistributed resource value scores are summed up on a resource-by-resource basis (S127).

The resource usage recorded in the parameter set management table 143 can be used here.

Thereafter, the resource value calculating module 130 records the resource value score of each parameter set in the parameter set management table 143 (S131). The resource value calculating module 130 determines whether or not every value item 1311 has been read out of the discretionary distribution definition 131 (S132).

When it is determined as a result that a resource value score has been calculated for every value item 1311, the resource value calculating processing is ended. In the case where resource value scores have not been calculated for some value items 1311, the resource value calculating module 130 returns to Step S122 to obtain the next value item 1311.

In the case where the resource-by-resource distribution definition 132 is not found, the resource value calculating module 130 obtains the resource value information 133 (S128), and calculates an evaluation value (resource value score) of each parameter set based on the obtained resource value information 133 and the resource usage (S129). The resource value calculating module 130 then distributes resource value scores based on the proportion of the evaluation value of each parameter set (S130). In Step S130, the resource value scores are distributed in proportion to the reciprocal number of the evaluation value (the total amount of money), for example. The resource value calculating module 130 proceeds to S131, where the resource value score of each parameter set is recorded in the parameter set management table 143.

The resource usage recorded in the parameter set management table 143 can be used in Step S129.

A specific example of calculating resource value scores is described next.

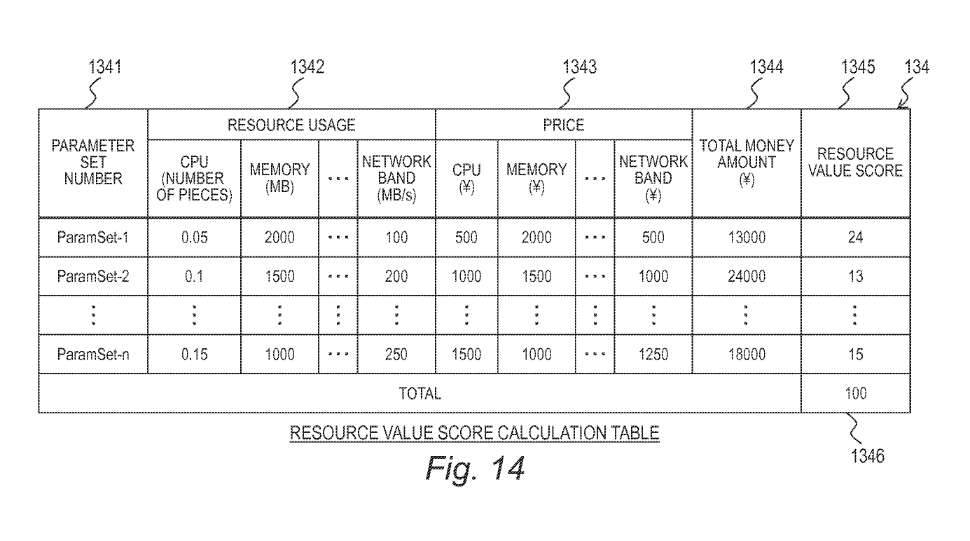

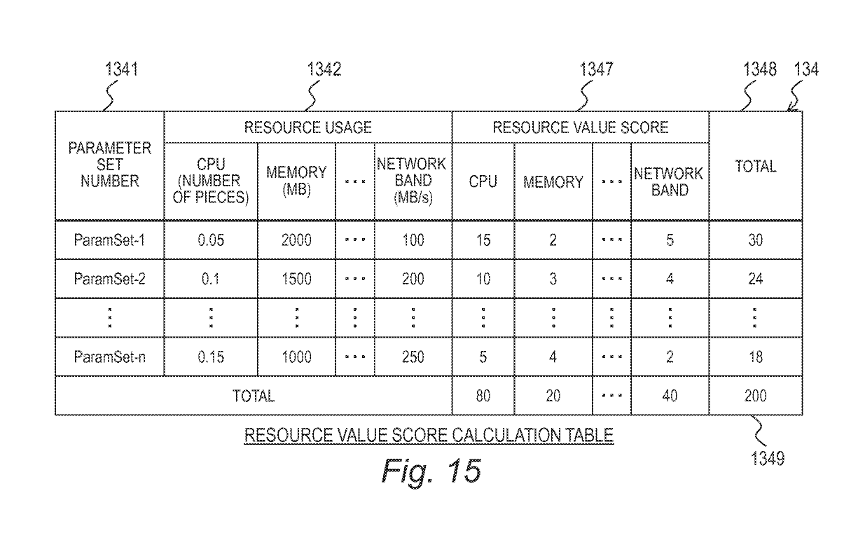

FIG. 14 and FIG. 15 are diagrams for showing examples of the resource value score calculation table 134 of this embodiment. The resource value score calculation table 134 is intermediate data that is used by the resource value calculating module 130 to calculate the resource value score of a parameter set.

In the case where the resource-by-resource distribution definition 132 is not found (No in Step S123), the resource value calculating module 130 calculates an evaluation value (the total amount of money) of each parameter set based on the discretionary distribution definition 131 and the resource value information 133 (S128 to S130).

For example, the resource value calculating module 130 distributes resource value scores among parameter sets so that a total 1346 of resource value scores in the resource value score calculation table 134 of FIG. 14 is equal to a resource value score of 100 points which is distributed to price in the discretionary distribution definition 131 of FIG. 4 (S129). The resource value calculating module 130 further redistributes resource value scores among parameter sets based on the proportion of the total amount of money so that a parameter set small in total money amount is given more points (S130). A resource value score distributed to each parameter set is an evaluation value of the parameter set in the “price” aspect.

In the case where the resource-by-resource distribution definition 132 is found (Yes in Step S123), on the other hand, the resource value calculating module 130 calculates the evaluation value (the total amount of money) of each parameter set based on the discretionary distribution definition 131, the resource-by-resource distribution definition 132, and the resource value information 133 (S124 to S127).

For example, the resource value calculating module 130 distributes resource value scores among parameter sets so that the total 1349 of resource value scores in the resource value score calculation table 134 of FIG. 15 is equal to a resource value score of 200 points which is distributed to free capacity in the discretionary distribution definition 131 of FIG. 4 in accordance with the value distribution 1322 of the resource-by-resource distribution definition 132 (S125).

The resource value calculating module 130 further redistributes resource value scores among resources based on the resource usage so that a parameter set small in resource usage is given more points as a total 1348 of resource value scores 1347, which are resource value scores distributed on a resource-by-resource basis. The total of resource value scores distributed on a resource-by-resource basis is an evaluation value of the parameter set in the “free capacity” aspect.

When the resource value score is recorded in the parameter set management table 143, the management table displaying module 170 outputs screen data for displaying the parameter set selection screen to the terminal 180.

FIG. 16 is a diagram for illustrating an example of the parameter set selection screen 171 of this embodiment.

The parameter set selection screen 171 includes a parameter set management table display area 1711, a parameter set selection area 1712, and a “select” operation button 1713.

The parameter set management table display area 1711 displays the parameter set management table 143. The parameter set management table 143 displayed in the parameter set selection screen 171 is sorted in descending order of the total resource value score. Scroll bars are provided to the right and below the parameter set management table display area 1711, and are used to switch an area of the parameter set management table 143 in the parameter set management table display area 1711 that is displayed on the screen.

The user of the parameter designing system 100 clicks the parameter set selection area 1712 to pick up a parameter set that fulfills performance requirements and that has a high score, and operates the “select” operation button 1713 to select the parameter set.

Instead of the user of the parameter designing system 100, the parameter designing system 100 may automatically select a parameter set that has a high score. Specifically, the parameter applying module 121 selects a parameter set that has the highest resource value score, and applies the parameter set to a business operation system.

As described above, according to the embodiment of this invention, parameters for building a system in a virtual environment can be designed quickly.

The discretionary distribution definition 131 defines which resource value is given importance in the form of the distribution of resource value scores, and the resource-by-resource distribution definition 132 defines which resource is given importance in a resource value aspect in the form of the distribution of resource value scores. Parameters for building a system that reflects a design concept in more detail can therefore be determined.

The resource value calculating module 130 redistributes resource value scores among resources based on the resource-by-resource distribution definition 132, and re-redistributes the distributed resource value scores among parameter sets based on the proportion of the resource usage. A system that reflects a design concept in more detail can therefore be built by following a definition that defines how each resource is weighted.

The resource value calculating module 130 calculates an evaluation value of each parameter set based on the resource value information 133 and the resource usage, and distributes resource value scores based on the proportion of the evaluation value of each parameter set. Parameters for a virtual environment can therefore be designed even when how each resource is weighted is not defined.

The resource value information obtaining module 150 may be configured to collect information and generate resource value information.

The management table displaying module 170 generates screen data for displaying the calculated resource value scores of the parameter sets in an order of the determined total resource value scores of the parameter sets. The management table can therefore be displayed in a manner that is easy for the user to understand the direction of system designing.

The parameter applying module 121 applies a parameter set that has the highest resource value score to a virtual environment. A uniform result can therefore be obtained in system designing without troubling the user.

The discretionary distribution definition 131 and the resource-by-resource distribution definition 132 define priority about at least one of resource price and free resource capacity. A uniform result can therefore be obtained in system designing without troubling the user.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, processing modules, and processing means, for all or a part of them, may be implemented by hardware: for example, by designing an integrated circuit. The above-described configurations and functions may be implemented by software, which means that a processor interprets and executes programs providing the functions.

The information of programs, tables, and files to implement the functions may be stored in a storage device such as a memory, a hard disk drive, or an SSD (Solid State Drive), or a storage medium such as an IC card, or an SD card.

The drawings illustrate control lines and information lines as considered necessary for explanation but do not show all control lines or information lines in the products. It can be considered that almost of all components are actually interconnected.

1. A design assisting system, comprising:
a processor configured to execute a program; and
a memory configured to store the program to be executed by the processor,
the memory being configured to store a plurality of parameter sets for defining usage of resources of a computer system on which a business operation is run, and
the processor being configured to:
calculate a resource value score of each resource for each of the plurality of parameter sets, based on information for defining items to be taken into account in system designing;
sum up the calculated resource value scores for each of the plurality of parameter sets separately; and
determine a priority level of each of the plurality of parameter sets, based on the resource value scores summed up for each of the plurality of parameter sets separately.

2. The design assisting system according to claim 1, wherein the information for defining items to be taken into account in system designing includes a discretionary distribution definition for defining a resource value to be given importance in a form of distribution of resource value scores, and a resource-by-resource distribution definition for defining a resource to be given importance in an aspect of the resource value in the form of distribution of resource value scores.

3. The design assisting system according to claim 2, wherein the processor is configured to distribute the resource value scores to the resources based on the resource-by-resource distribution definition, further distribute the distributed resource value scores based on a proportion of the resource usage, and sum up the distributed resource value scores for each of the plurality of parameter sets separately.

4. The design assisting system according to claim 1,
wherein the design assisting system is configured to have access to resource value information for defining a resource value, which changes dynamically depending on a situation of the computer system, and
wherein the processor is configured to calculate an evaluation value of each of the plurality of parameter sets based on the resource value information and on the resource usage, and distribute the resource value scores based on a proportion of the evaluation value of each of the plurality of parameter sets.

5. The design assisting system according to claim 4, wherein the resource value information is generated by using information that is collected via a network.

6. The design assisting system according to claim 1, wherein the design assisting system is configured to generate screen data for displaying the calculated resource value score of each of the plurality of parameter sets in an order of the determined priority level of each of the plurality of parameter sets.

7. The design assisting system according to claim 1, wherein the processor is configured to build a virtual computer to which a parameter set of the highest priority level determined is applied.

8. The design assisting system according to claim 1, wherein the information for defining items to be taken into account in system designing defines weighting about at least one of resource price or free resource capacity.

9. A design assisting method to be executed by a computer system,
the computer system including a processor configured to execute a program and a memory configured to store the program to be executed by the processor,
the memory being configured to store a plurality of parameter sets for defining usage of resources of another computer system on which a business operation is run,
the design assisting method comprising the steps of:
calculating, by the processor, a resource value score of each resource for each of the plurality of parameter sets, based on information for defining items to be taken into account in system designing;
summing up, by the processor, the calculated resource value scores for each of the plurality of parameter sets separately; and
determining, by the processor, a priority level of each of the plurality of parameter sets, based on the resource value scores summed up for each of the plurality of parameter sets separately.

10. The design assisting method according to claim 9, wherein the information for defining items to be taken into account in system designing includes a discretionary distribution definition for defining a resource value to be given importance in a form of distribution of resource value scores, and a resource-by-resource distribution definition for defining a resource to be given importance in an aspect of the resource value in the form of distribution of resource value scores.

11. The design assisting method according to claim 10, further comprising steps of:
distributing, by the processor, resource value scores to the resources based on the resource-by-resource distribution definition;
further distributing, by the processor, the distributed resource value scores based on a proportion of the resource usage; and
summing up, by the processor, the distributed resource value scores for each of the plurality of parameter sets separately.

12. The design assisting method according to claim 9,
wherein the computer system is configured to have access to resource value information for defining a resource value, which changes dynamically depending on a situation of the another computer system,
wherein the design assisting method further comprises steps of:
calculating, by the processor, an evaluation value of each of the plurality of parameter sets based on the resource value information and on the resource usage; and
distributing, by the processor, the resource value scores based on a proportion of the evaluation value of each of the plurality of parameter sets.

13. The design assisting method according to claim 12, further comprising generating the resource value information by using information that is collected via a network.

14. The design assisting method according to claim 9, further comprising a step of generating screen data for displaying the calculated resource value score of each of the plurality of parameter sets in an order of the determined priority level of each of the plurality of parameter sets.

15. The design assisting method according to claim 9, further comprising a step of building, by the processor, a virtual computer to which a parameter set of the highest priority level determined is applied.

16. The design assisting method according to claim 9, wherein the information for defining items to be taken into account in system designing defines weighting about at least one of resource price or free resource capacity.

17. A computer-readable, non-transitory storage medium having stored thereon a program for executing a design assisting method,
the computer including a processor configured to execute the program and a memory configured to store the program to be executed by the processor,
the memory being configured to store a plurality of parameter sets for defining usage of resources of a computer system on which a business operation is run,
the program controlling the computer to execute the procedures of:
calculating, by the processor, a resource value score of each resource for each of the plurality of parameter sets, based on information for defining items to be taken into account in system designing;
summing up, by the processor, the calculated resource value scores for each of the plurality of parameter sets separately; and
determining, by the processor, a priority level of each of the plurality of parameter sets, based on the resource value scores summed up for each of the plurality of parameter sets separately.
